(19) United States
(12) Patent Application Publication
(10) Pub. No.: US 2026/0237027 A1
(43) Pub. Date: Aug. 13, 2026

(54) APPARATUS AND METHOD WITH IMAGE PROCESSING PARAMETER ADJUSTMENT

(71) Applicant: Samsung Electronics Co., Ltd., Suwon-si (KR)

(72) Inventors: Wenfei JIAO, Xi’an (CN); Yuguang LI, Xi’an (CN); Ran YANG, Xi’an (CN); Pei YOU, Xi’an (CN); Sehwan KI, Suwon-si (KR); Jaehyoung YOO, Suwon-si (KR); Hyong Euk LEE, Suwon-si (KR)

(73) Assignee: Samsung Electronics Co., Ltd., Suwon-si (KR)

(21) Appl. No.: 19/532,212

(22) Filed: Feb. 6, 2026

(30) Foreign Application Priority Data
Feb. 8, 2025 (CN) 202510146916.6
Aug. 13, 2025 (KR) 10-2025-0111994

(51) Int. Cl. G06T 5/60; G06T 7/00; G06T 7/20

(52) U.S. Cl. CPC G06T 5/60; G06T 7/0002; G06T 7/20; G06T 2207/20084

(57) ABSTRACT

A method of adjusting a parameter of an image processing system including an image processing pipeline included of image processing stages, and the method includes: acquiring current state information indicating which of the image processing stages is a current image processing stage that is a target of adjustment among the image processing stages; determining an adjustment parameter using a parameter adjustment model to which the current state information is input and using a parameter generation method that generates the adjustment parameter; adjusting a current parameter in the current image processing stage based on the adjustment parameter; and performing the current image processing stage with the adjusted parameter therein.

### CROSS-REFERENCE TO RELATED APPLICATIONS

This application claims the benefit under 35 USC § 119(a) of Chinese Patent Application No. 202510146916.6, filed on Feb. 8, 2025, in the China National Intellectual Property Administration, and Korean Patent Application No. 10-2025-0111994, filed on Aug. 13, 2025, in the Korean Intellectual Property Office, the entire disclosures of which are incorporated herein by reference for all purposes.

### BACKGROUND

### 1. Field

The following description relates to an apparatus and method with image processing parameter adjustment.

### 2. Description of Related Art

Image signal processing (ISP) may involve improving the quality of an image or analyzing an image by processing a digital image or an image signal. For example, ISP techniques include lens correction, defective pixel correction, automatic exposure adjustment, noise reduction, color correction, and the like. An ISP process or pipeline may include an agent network-based parameter adjustment method and/or a reinforcement learning-based parameter adjustment method. An agent network-based parameter adjustment method may involve training a differentiable agent network instead of a non-differentiable module in an image processing system and adjusting a parameter in the image processing system using the trained agent network. A module (or a block) of an ISP system may perform a single ISP process or two or more ISP processes, among other signal processing processes. Such an ISP processes are distinguished by their functions and are often referred to as ISP stages. A reinforcement learning-based parameter adjustment method may perform image processing by combining different modules or stages in an image processing system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus is for adjusting a parameter of an image processing system including an image processing pipeline included of image processing stages, and the apparatus includes: one or more processors; and a memory storing instructions configured to, when executed by the one or more processors, cause the apparatus to: acquire current state information indicating which of the image processing stages is a current image processing stage that is a target of adjustment among the image processing stages; determine an adjustment parameter using a parameter adjustment model to which the current state information is input and using a parameter generation method that generates the adjustment parameter; adjust a current parameter in the current image processing stage based on the adjustment parameter; and perform the current image processing stage with the adjusted parameter therein.

The instructions, when executed by the one or more processors, may cause the apparatus to, by adjusting the current parameter of the current image processing stage and by adjusting a parameter of a next image processing stage after the current image processing stage, sequentially adjust the current parameter of the current image processing stage and the parameter of the next image processing stage.

The instructions, when executed by the one or more processors, may cause the apparatus to generate the current state information using a hot encoding parameter indicating the current image processing stage among the image processing stages and an output image of a previous image processing stage that is previous to the current image processing stage, which is acquired by performing the previous image processing stage.

The instructions, when executed by the one or more processors, may cause the apparatus to: acquire a current state vector by extracting, by the parameter adjustment model, a feature of the current state information; generate a motion vector representing, in a vector format, image processing to be performed in the current image processing stage based on the acquired current state vector and based on the parameter generation method; and acquire the adjustment parameter by parsing the motion vector.

The instructions, when executed by the one or more processors, may cause the apparatus to: acquire a semantic feature vector by extracting a feature from the output image of the previous stage; and acquire the current state vector by embedding the acquired semantic feature vector and the hot encoding parameter indicating the current image processing stage.

The instructions, when executed by the one or more processors, may cause the apparatus to acquire the motion vector by inputting the current state vector to a state-action evaluation model based on reinforcement learning, which is configured to evaluate the parameter adjustment model.

The state-action evaluation model may include a decision-making model configured to perform the parameter generation method and a Q network configured to evaluate the current state vector.

The instructions, when executed by the one or more processors, may cause the apparatus to acquire the adjustment parameter by converting the motion vector into a parameter format that is used in the image processing system.

The instructions, when executed by the one or more processors, may cause the apparatus to: determine a score for an evaluation item to evaluate the image processing system to which the adjustment parameter is applied; determine an image quality score, based on the score for the evaluation item and a weight for the evaluation item, with respect to an output image that is acquired from the image processing system to which the adjustment parameter is applied; and update the parameter generation method based on the determined image quality score.

The evaluation item may include an accuracy of detailed information of the output image, a color of the output image, a contrast ratio of the output image, or a brightness of the output image.

In another general aspect, there is a method of adjusting a parameter of an image processing system including an image processing pipeline included of image processing stages, and the method includes: acquiring current state information indicating which of the image processing stages is a current image processing stage that is a target of adjustment among the image processing stages; determining an adjustment parameter using a parameter adjustment model to which the current state information is input and using a parameter generation method that generates the adjustment parameter; adjusting a current parameter in the current image processing stage based on the adjustment parameter; and performing the current image processing stage with the adjusted parameter therein.

The adjusting of the current parameter may include, by adjusting the current parameter of the current image processing stage and by adjusting a parameter of a next image processing stage, sequentially adjusting the current parameter of the current image processing stage and the parameter of the next image processing stage.

The acquiring of the current state information may include generating the current state information using a hot encoding parameter indicating the current image processing stage among the image processing stages and using an output image of a previous image processing stage that is previous to the current image processing stage, which is acquired by performing the previous image processing stage.

The determining of the adjustment parameter may include: acquiring a current state vector by extracting, by the parameter adjustment model, a feature of the current state information; generating a motion vector representing, in a vector format, image processing to be performed in the current image processing stage based on the acquired current state vector and based on the parameter generation method; and acquiring the adjustment parameter by parsing the motion vector.

The acquiring of the current state vector may include: acquiring a semantic feature vector by extracting a feature from the output image of the previous stage; and acquiring the current state vector by embedding the acquired semantic feature vector and the hot encoding parameter indicating the current image processing stage.

The generating of the motion vector may include acquiring the motion vector by inputting the current state vector to a state-action evaluation model based on reinforcement learning, which is configured to evaluate the parameter adjustment model.

The state-action evaluation model may include a decision-making model configured to perform the parameter generation method and a Q network configured to evaluate the current state vector.

The acquiring of the adjustment parameter may include acquiring the adjustment parameter by converting the motion vector into a parameter format that is used in the image processing system.

The method may further include: determining a score for an evaluation item to evaluate the image processing system to which the adjustment parameter is applied; determining an image quality score, based on the score for the evaluation item and a weight for the evaluation item, with respect to an output image that is acquired from the image processing system to which the adjustment parameter is applied; and updating the parameter generation method based on the determined image quality score.

In another general aspect, a non-transitory computer-readable storage medium stores executable program instructions, and the executable program instructions, when executed by a computing system, cause the computing system to perform, for an image processing pipeline included of image processing stages: acquiring current state information indicating which of the image processing stages is a current image processing stage that is a target of adjustment among the image processing stages, wherein the current state information includes a hot encoding parameter indicating the current image processing stage among the image processing stages and an output image of an image processing stage that is previous to the current image processing stage, wherein the output image is acquired by performing the previous image processing stage; determining an adjustment parameter using a parameter adjustment model to which the current state information is input and using a parameter generation method that generates the adjustment parameter; adjusting a current parameter in the current image processing stage based on the adjustment parameter; and performing the current image processing stage with the adjusted parameter therein.

Other features and aspects will be apparent from the following detailed description, the drawings, and the claims.

### BRIEF DESCRIPTION OF THE DRAWINGS

FIG. 1 illustrates example operations of a parameter adjustment method, according to one or more embodiments.

FIG. 2A illustrates an example of current state information according to one or more embodiments.

FIG. 2B illustrates an example of a hot encoding parameter according to one or more embodiments.

FIG. 3 illustrates an example of a parameter adjustment model and a state-action evaluation model, according to one or more embodiments.

FIG. 4 illustrates an example of generating a state vector, according to one or more embodiments.

FIG. 5 illustrates an example of updating a state-action evaluation model, according to one or more embodiments.

FIG. 6 illustrates an example of adjusting a parameter of an image processing system, according to one or more embodiments.

FIG. 7 illustrates an example of a module of a parameter adjustment apparatus, according to one or more embodiments.

FIG. 8 illustrates an example of a configuration of a parameter adjustment apparatus, according to one or more embodiments.

Throughout the drawings and the detailed description, unless otherwise described or provided, the or like same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

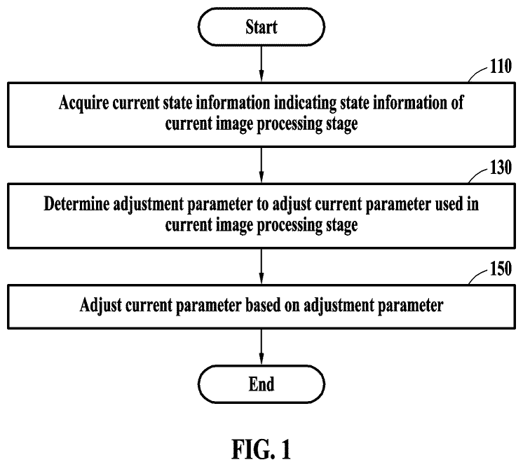

FIG. 1 illustrates example operations of a parameter adjustment method, according to one or more embodiments.

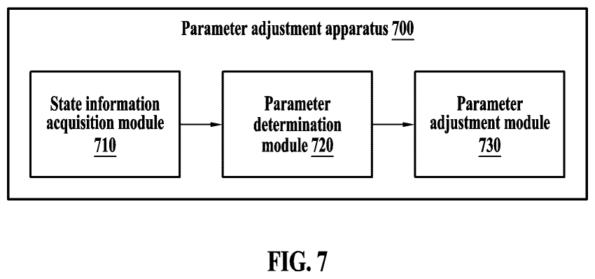

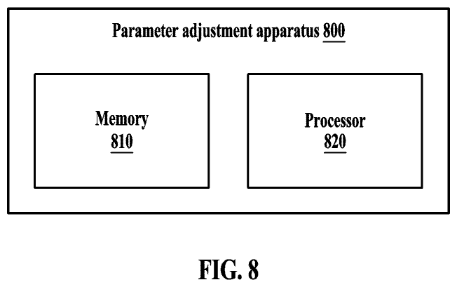

The operations of the parameter adjustment method may be performed by a parameter adjustment apparatus (e.g., the parameter adjustment apparatus 700 shown FIG. 7 or the parameter adjustment apparatus 800 shown in FIG. 8). The parameter adjustment apparatus may adjust a parameter of an image processing system, for example, an image signal processing system. The image processing system may perform processing on an input image (e.g., image analysis, image transformation, object extraction, inference on an image, or the like). The parameter adjustment apparatus may acquire state information from the image processing system and generate a motion vector based on the state information.

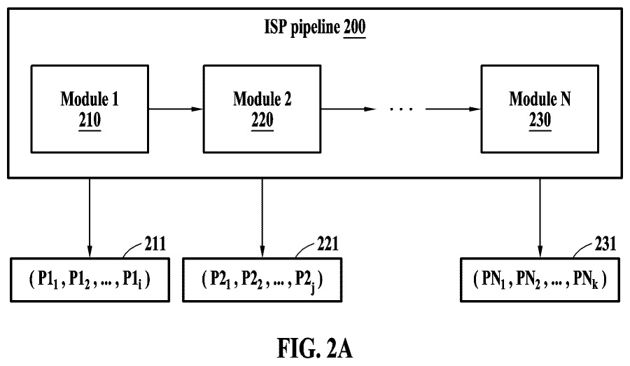

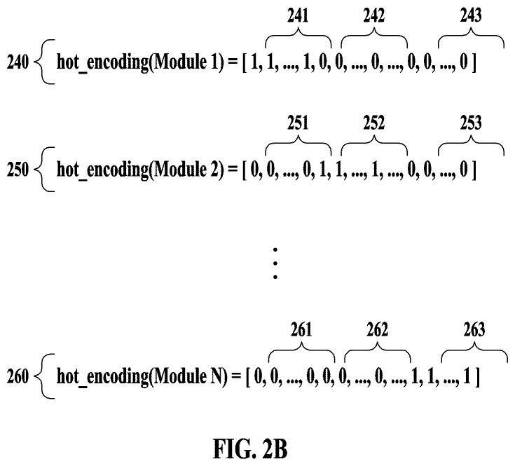

The state information may indicate information about current state of the current image processing stage that is a target of adjustment; the current target image processing stage is one of the image processing stages of the image processing system. For example, the state information may include a hot encoding parameter indicating or identifying the current image processing stage that is the target for parameter adjustment among the image processing stages. For example, as shown in FIG. 2B, the hot encoding parameter may be a binary vector whose elements represents the respective processing stages and all elements may have a zero value except for the element representing the target current image processing stage, which may have a one value, which indicates that the target image processing stage. The state information may also include an output image of a stage preceding (or previous to) the target image processing stage (e.g., an image to be inputted to the target image processing stage).

The motion vector may indicate information about image processing to be performed in the current image processing stage. The information about image processing may be in a vector format. The parameter adjustment apparatus may acquire an adjustment parameter that is applicable to the image processing system by parsing the motion vector. Parsing may involve converting the format of the motion vector. In other words, the parameter adjustment apparatus may acquire a parameter in a data format that is used in the image processing system, and may do so by converting the format of the motion vector.

The parameter adjustment apparatus may evaluate a score for the image processing system to which the adjustment parameter has been applied. The parameter adjustment apparatus may improve the efficiency of parameter adjustment by updating the parameter generation method using the evaluated score. In other words, the adjusted parameter may cause the current/target image processing stage to better perform its image processing.

Since a reinforcement learning-based machine learning model is used, the state information that is used to generate the adjustment parameter may be determined based on an input image that is input to a module (e.g., module 1 210 of FIG. 2A), and, an output image that is output from the module and may be irrelevant to the differentiability of the module. Since the modules (or image processing stages) of the image processing apparatus are adjusted sequentially, the number of parameters that need to be adjusted in each module may not be limited (i.e., any number of parameters may potentially be adjusted). Accordingly, the parameter adjustment apparatus may update the parameter generation method even when the module is not differentiable, and there may be no limit to the number of parameters used in the process of updating the module so that the efficiency of parameter adjustment may be improved by adjusting the parameter more flexibly than before.

Referring to FIG. 1, In some embodiments, the parameter adjustment apparatus may adjust parameter(s) of each image processing stage of an image processing pipeline, one after the other. The “current image processing stage” refers to whichever stage is currently being adjusted. In other words, process shown in FIG. 1 may be repeated for each of the stages in sequence. Alternatively or additionally, the current image processing stage may be individually selected on any basis, for example, a basis that indicates that a stage needs or would benefit parameter adjustment. For example, an output image of a given stage may be analyzed to determine a quality of the output image with respect to the type of image processing performed by that stage, and if the quality is below a threshold then the given stage may be determined to be a current stage subject to parameter adjustment. As another example, image properties (e.g., clarity, color balance, blur, etc.) of an output image of the image processing pipeline may be measured and those properties with sufficiently high/low measures may be selected for parameter adjustment (each in turn being processed as the current image processing stage).

In operation 110, the parameter adjustment apparatus may acquire current state information indicating state information of the current image processing stage. The parameter adjustment apparatus may determine whether the current image processing stage requires adjustment in the image processing system. Current state information of an image processing stage that is determined to be a target of adjustment may be acquired. The acquired current state information may include information indicating the image processing stage that is a target of adjustment and an image that is a target of image processing (i.e., an input to the determined target stage). For example, the current state information may include the hot encoding parameter and the output image of the previous stage. The current state information may be determined by the hot encoding parameter, and, the output image of the previous stage and may not be affected by the differentiability of the processing stage that is a target of adjustment. When the processing stage that is a target of adjustment is the first/initial processing stage among the processing stages, the “output image of the previous stage” may be an input image (e.g., an original image). The current state information may further include, but is not limited thereto, parameters currently used (or in effect) in each image processing stage of the image processing system. For example, the current state information may include sets of parameters of the respective stages, each set identifiable/selectable according to its corresponding stage (e.g., by a stage index).

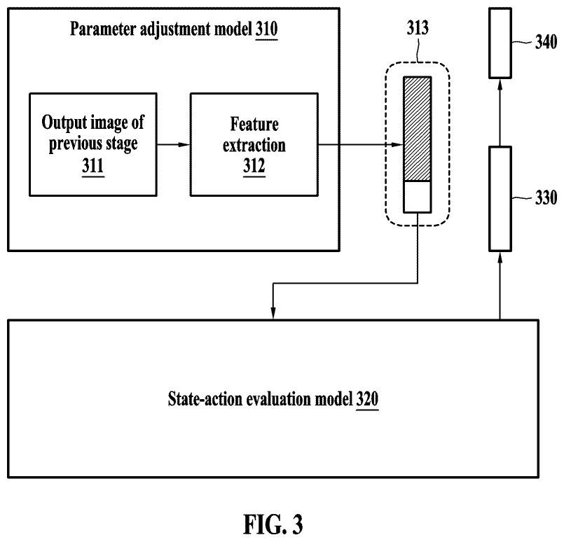

In operation 130, the parameter adjustment apparatus may determine/identify the adjustment parameter to be adjusted, which may be a current parameter used in the current/target image processing stage. The adjustment parameter may be determined/identified (or selected) using a parameter adjustment model (to which the current state information is inputted) and using the parameter generation method. The adjustment parameter may be determined/identified in order to adjust its value. The parameter adjustment model may be a machine learning model (or an agent network) used to adjust the value of a parameter used in the image processing system (e.g., the selected adjustment parameter). The parameter generation method may be performed with a machine learning model (e.g., a decision-making network) that generates a value of the parameter used in image processing. For example, the parameter generation method may include generate the motion vector using a current state vector as an input (or an input basis) to a decision-making network (or a decision-making model). The decision-making network may be a machine learning model based on reinforcement learning in which an input is the current state vector and an output is the motion vector. The parameter adjustment apparatus may acquire a state vector by extracting a feature from the current state information and acquire the adjustment parameter by parsing the acquired state vector. The acquisition of the state vector and adjustment parameter by the parameter adjustment apparatus is described in more detail below with reference to FIG. 3.

In operation 150, the parameter adjustment apparatus may adjust the current parameter based on the adjustment parameter. The parameter adjustment apparatus may be used in any or all image processing stages performed by the image processing system. The parameter adjustment apparatus may be used to adjust the parameters used in each image processing stage. The parameter adjustment apparatus may sequentially adjust the parameters of the image processing stages for which parameter adjustment is to be performed using the parameter generation method and the current state information. Since the parameter adjustment apparatus sequentially adjusts the parameters of the image processing stages requiring parameter adjustment, the parameter adjustment apparatus may adjust the parameters without limitation on the number of parameters requiring adjustment in each image processing stage.

The parameter adjustment apparatus, according to an example, may determine a score for an evaluation item to evaluate the image processing system. The adjustment parameter may be applied to the image processing system. The parameter adjustment apparatus may determine the score for the evaluation item by inputting an output image, which is acquired from the image processing system, to an image quality evaluation model. The evaluation item may include, for example, but is not limited thereto, the expression accuracy of detailed information (e.g., sharpness or blur), a color, a contrast ratio, and/or brightness of the output image.

The parameter adjustment apparatus may determine an image quality score for the output image based on the score for the evaluation item and a weight for the evaluation item. The output image may be an image acquired from the image processing system to which the adjustment parameter is applied. The weight may be a numerical representation of the sensitivity of the human eye to the evaluation item. The human eye may tend to be more sensitive to the overall brightness of an image than to the details at the boundary portion of the image. In this case, for example, a weight of the brightness of the image may be 0.6, and a weight of the details of the image may be 0.4. The parameter adjustment apparatus may improve the efficiency of parameter adjustment by varying the weight for the evaluation item.

The parameter adjustment apparatus may update the parameter generation method based on the determined image quality score. The parameter adjustment apparatus may improve the accuracy of the parameter generation method by updating the parameter generation method described above, and the image processing system may output a processed image with high quality.

FIG. 2A illustrates an example of current state information according to one or more embodiments.

Referring to FIG. 2A, a parameter adjustment apparatus may generate current state information for each module (or stage) of an image signal processing (ISP) pipeline 200. For example, the parameter adjustment apparatus may generate the current state information using a hot encoding parameter and an output image of a previous stage. The ISP pipeline 200 may include consecutive image processing stages performed by an image processing system. The ISP pipeline 200 may include module 1 210, and module 2 220 to module N 230. Each module may implement an image processing stage. For example, N modules may be N image processing stages. In some implementations, hardware modules may correspond to the N modules, not necessarily on a one-to-one basis.

Module 1 210, module 2 220, and the modules up to module N 230 may implement the N respective consecutive image processing stages of the ISP pipeline 200. Module 1 210 to module N 230 may include hardware and software configurations corresponding to the processing stages. The parameter adjustment apparatus may acquire first current state information 211 corresponding to module 1 210 (or a first image processing stage), second current state information 221 corresponding to the module 2 220 (or a second image processing stage), up to N-th current state information 231 corresponding to the module N 230 (or an N-th image processing stage). The first current state information 211 may be i-dimensional information (e.g., parameter values) of the first image processing stage, the second current state information 221 may be j-dimensional information of the second image processing stage, so forth, up the N-th current state information 231 which may be k-dimensional information of the N-th image processing stage. The first current state information 211 through the N-th current state information 231 may each include an output of the corresponding previous module (or a previous processing stage), a hot encoding parameter indicating a current module (or a current processing stage), and an output of the ISP pipeline 200. The current state information of a current module may be in a form expressed by Equation 1 below, as a non-limiting example.

$${s}^{module} = \{ {I}_{prev \_ output} , hot\_encoding ( Module ) , {I}_{pipeline \_ output} \} \qquad Equation 1$$

In Equation 1, s^{module} denotes current state information, I_{prev_output} denotes an output (e.g., an image) of the module previous to the current module (when the current module is the first module, I_{prev_output} may be the image inputted to the ISP pipeline 200). hot_encoding(Module) denotes a hot encoding parameter indicating the current module (or the current processing stage) and I_{pipeline_output} (e.g., an image) denotes an output of the ISP pipeline 200 corresponding to the image inputted to the ISP pipeline 200. The hot encoding parameter is described with reference to FIG. 2B.

FIG. 2B illustrates an example of a hot encoding parameter, according to one or more embodiments.

Referring to FIG. 2B, the hot encoding parameter (hot_encoding(Module)) may indicate which module is the current module (or the current processing stage) that is the target of adjustment. In the hot encoding parameter, the value of the module (or the processing stage) that is currently being adjusted may be 1, and the values of the remaining modules (or processing stages) may be 0. As shown in FIG. 2A, among N modules (or processing stages), any one of the modules may be adjusted (i.e., may be the current/target module). In a first hot encoding parameter 240, a value 241 of module 1 (or a first processing stage) that is currently being adjusted may be 1, and the value 242 of module 2 (or a second processing stage) to the value 243 of module N (or an N-th processing stage) may be 0. In a second hot encoding parameter 250, the value 252 of the module 2 (or the second processing stage) that is currently being adjusted may be 1, and the value 251 of the module 1 (or the first processing stage) and a value 253 of module 3 (not shown) (or a third processing stage) to the module N (or the N-th processing stage) may be 0. In an N-th hot encoding parameter 260, the value 263 of the module N (or the N-th processing stage) that is currently being adjusted may be 1, and the value 261 of the module 1 (or the first processing stage), the value 262 of the module 2 (or the second processing stage), and so forth to the value (not shown) of module N−1 (or an N−1-th processing stage) may be 0.

FIG. 3 illustrates an example of a parameter adjustment model and a state-action evaluation model, according to one or more embodiments.

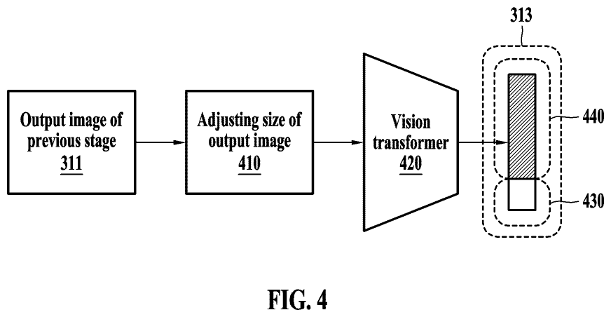

Referring to FIG. 3, a parameter adjustment apparatus (e.g., parameter adjustment apparatus 700 of FIG. 7 or parameter adjustment apparatus 800 of FIG. 8) may acquire a current state vector 313 from a parameter adjustment model 310. The parameter adjustment apparatus may acquire the current state vector 313 by the parameter adjustment model 310 extracting a feature of current state information based on the current state information being input thereto. For example, the parameter adjustment model 310 may acquire the output image of a previous stage 311 by preprocessing the current state information. The parameter adjustment model 310 may extract the current state vector 313 by performing a feature extraction 312 operation on the output image of the previous stage 311. The acquisition of the current state vector 313 by the parameter adjustment apparatus is described with reference to FIG. 4.

The parameter adjustment apparatus may generate a motion vector 330 based on the current state vector 313 and a parameter generation method. The motion vector 330 may represent, in a vector format, image processing to be performed by an image processing system. The parameter adjustment apparatus may acquire the motion vector 330 from a state-action evaluation model 320 to which the current state vector 313 is input. The parameter adjustment apparatus may improve the accuracy of the motion vector 330, using the state-action evaluation model 320 for acquisition of the motion vector 330. The state-action evaluation model 320 may be a reinforcement learning-based machine learning model and may include a decision-making model that performs the parameter generation method. Description of the state-action evaluation model 320 follows.

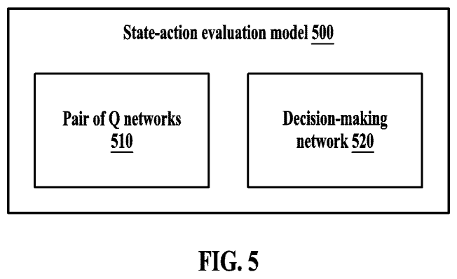

The state-action evaluation model 320 may be implemented as, for example, a soft actor-critic (SAC) framework. The state-action evaluation model 320 may include a reinforcement learning-based machine learning model that is trained using an off-policy training method based on the maximum entropy framework. The maximum entropy framework may find policies that maximize rewards while attempting as many different actions as possible. The off-policy training method may train using data acquired through past (or other) policies. The state-action evaluation model 320 may be a random strategy algorithm based on the maximum entropy framework and may increase the diversity of actions while maximizing profits. The structure and updating of the state-action evaluation model 320 are described with reference to FIG. 5.

The parameter adjustment apparatus may acquire an adjustment parameter 340 by parsing the generated motion vector 330. For example, the parameter adjustment apparatus may acquire the adjustment parameter 340 by converting the generated motion vector 330 into a parameter format that is used in the image processing system. The format of the parameter may be a parameter space but is not limited thereto. Parsing may include an operation of applying a hyperbolic tangent function and a normalization operation. Converting the motion vector 330 may be performed with code described Equation 2 below.

$${a}_{t} = Norm ( tanh ( {a}_{t}^{′} ) ) \qquad Equation 2$$

In Equation 2, aₜ denotes the adjustment parameter 340 obtained by converting the motion vector 330, aₜ′ denotes the motion vector 330, Norm denotes normalization, and tanh denotes a hyperbolic tangent function.

FIG. 4 illustrates an example of generating a state vector, according to one or more embodiments.

Referring to FIG. 4, a parameter adjustment apparatus (e.g., parameter adjustment apparatus 700 of FIG. 7 or parameter adjustment apparatus 800 of FIG. 8) may acquire the current state vector 313 by extracting a feature of current state information from a parameter adjustment model to which the current state information is input. As used herein, data “input” to a model may be directly inputted to the model, or may go through some transformation before being inputted to the model.

The output image of the previous stage 311 may be inputted to the parameter adjustment model, and the parameter adjustment model may first preprocess the output image of the previous stage 311. For example, the parameter adjustment model may perform, as preprocessing, operation 410 of adjusting the size of the output image of the previous stage 311. The parameter adjustment model may be based on (or include) a vision transformer 420. The vision transformer 420 may be a machine learning model (e.g., a neural network) that divides an input image into patches, extracts a feature of the input image using the patches, and performs image recognition and inference using the extracted feature. For example, the vision transformer 420 may be a small transformer. The small transformer may be implanted/trained with knowledge trained by a large transformer through knowledge distillation. Through knowledge distillation, the small transformer may conserved limited computing resources while having near the high performance of the large transformer.

The vision transformer 420 may extract a feature from a resized image. For example, the extracted feature may be a semantic feature vector 440. The parameter adjustment apparatus may acquire the current state vector 313 by embedding the acquired semantic feature vector 440 and a hot encoding parameter 430 indicating a current image processing stage. Embedding may include a process of connecting or mapping the semantic feature vector 440 to the hot encoding parameter 430. The current state vector 313 may in a form described by Equation 3 below.

$${s}^{agent} = concat ( {f}^{agent} , hot\_encoding ( Module ) ) \qquad Equation 3$$

In Equation 3 s^{agent} denotes the current state vector 313, concat denotes embedding, f^{agent} denotes the semantic feature vector 440, and hot_encoding(Module) denotes the hot encoding parameter 430.

FIG. 5 illustrates an example of updating a state-action evaluation model, according to one or more embodiments.

Referring to FIG. 5, a state-action evaluation model 500 may include a pair of Q networks 510 and a decision-making network 520. A Q network is a type of neural network used in reinforcement learning to predict the value of taking a specific action in a given state. It may replace a traditional lookup table in Q-learning to handle environments with very large or continuous state spaces. A Q network may take a current state as input and may output the predicted “Q-value” for each possible action.

The pair of Q networks 510 may evaluate (perform an inference on) an operation of an image processing system and update the decision-making network 520 using the evaluation result. The updating of the decision-making network 520 may implemented as described by Equation 4 below.

$${J}_{π} ( ϕ ) = {E}_{{s}_{t}^{agent} ∼ D} [ {π}_{θ} ( {s}_{t}^{agent} ) [ k log ( {π}_{φ} ( {s}_{t}^{agent} ) ) - {Q}_{θ} ( {s}_{t}^{agent} ) ] ] \qquad Equation 4$$

In Equation 4,

$${s}_{t}^{agent}$$

denotes a current state vector at time t,

$${π}_{θ} ( {s}_{t}^{agent} )$$

denotes a motion vector generated by the decision-making network 520 based on the current state vector,

$${Q}_{θ} ( {s}_{t}^{agent} )$$

denotes an evaluation value obtained by evaluating the current state vector by the Q network at the time t, k denotes an entropy scale factor, D denotes an experience replay buffer, and E denotes an expected profit.

The updating of the Q network may be performed as described by 5 below.

$${J}_{Q} θ = {E}_{( {s}_{t}^{agent} , {a}_{t} ) ∼ D} [ \frac{1}{2} ( {Q}_{θ} ( {s}_{t}^{agent} ) - ( r ( {s}_{t}^{agent} , {a}_{t} ) + {γπ}_{φ} ( {s}_{t}^{agent} ) [ {Q}_{θ} ( {s}_{t + 1}^{agent} ) - k log π ( {s}_{t + 1}^{agent} ) ] ) ) ] \qquad Equation 5$$

In Equation 5,

$${s}_{t}^{agent}$$

denotes a current state vector at time t,

$${π}_{φ} ( {s}_{t}^{agent} )$$

denotes a motion vector generated by the decision-making network 520 at the time t, and

$${Q}_{θ} ( {s}_{t}^{agent} )$$

denotes an evaluation value obtained by evaluating the current state vector by the Q network at the time t. k denotes an entropy scale factor, D denotes an experience replay buffer, E denotes an expected profit, r denotes a profit value when an operation is performed using the current state vector, γ denotes a discount factor,

$$( {s}_{t + 1}^{agent} )$$

denotes a current state vector at time t+1,

$${Q}_{θ} ( {s}_{t + 1}^{agent} )$$

denotes an evaluation value obtained by evaluating a current state vector by the Q network at the time t+1, and

$$π ( {s}_{t + 1}^{agent} )$$

denotes a motion vector generated by the decision-making network 520 using the current state vector at the time t+1.

In the process of updating the pair of Q networks 510 and the decision-making network 520, a parameter adjustment model (e.g., the parameter adjustment model 310 of FIG. 3) corresponding to an agent network may be updated with them. Through the update process described above, the parameter adjustment model may gain the ability to acquire a current state vector (e.g., the current state vector 313 of FIG. 3) using an input image (e.g., an image output from image processing of a previous stage), and the state-action evaluation model 500 may have an ability to acquire a motion vector (e.g., the motion vector 330 of FIG. 3).

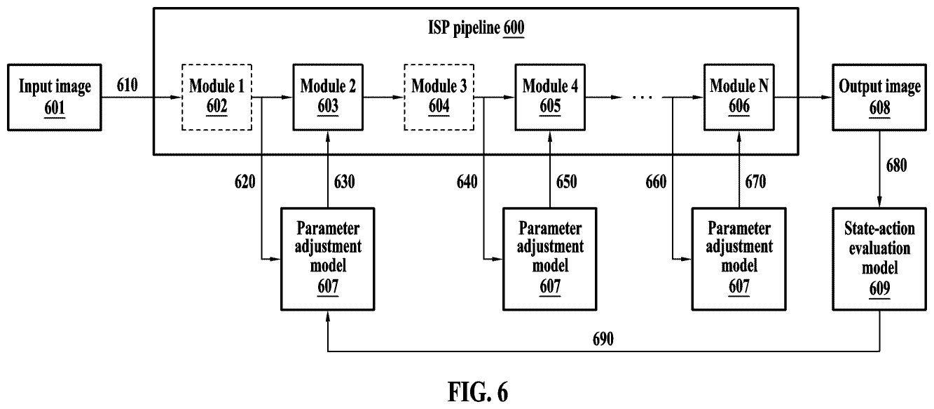

FIG. 6 illustrates an example of adjusting a parameter of an image processing system, according to one or more embodiments.

Referring to FIG. 6, a parameter adjustment apparatus (e.g., the parameter adjustment apparatus 700 of FIG. 7 or the parameter adjustment apparatus 800 of FIG. 8) may include an ISP pipeline 600, a parameter adjustment model 607, and a state-action evaluation model 609. The ISP pipeline 600 may correspond to the ISP pipeline 200 of FIG. 2. The parameter adjustment apparatus may adjust the parameters of any modules (any image processing stages) targeted for parameter adjustment of the ISP pipeline 600 using the same parameter adjustment model 607. As noted above, each module may correspond to an image processing stage performed by an image processing system.

In operation 610, the parameter adjustment apparatus may input an input image 601 (e.g., an original image) to module 1 602 of the ISP pipeline 600.

In operation 620, the parameter adjustment apparatus may determine current state information of module 2 603 based on an output image 608 of module 1 602 and a hot encoding parameter of module 2 603 and may input the current state information of module 2 603 to the parameter adjustment model 607.

In operation 630, the parameter adjustment apparatus may acquire an adjustment parameter for the module 2 603 from the parameter adjustment model 607 and update a current parameter of module 2 603 using the acquired adjustment parameter for module 2 603. Updating may include a process of adjusting a current parameter to the adjustment parameter. That is, adjusting a current parameter that controls how the module performs its image processing function (e.g., controls color adjustment, blur removal, or the like).

In operation 640, the parameter adjustment apparatus may determine current state information of module 4 605 based on the output image 608 of module 3 604 and a hot encoding parameter of module 4 605 and may input the current state information of module 4 605 to the parameter adjustment model 607.

In operation 650, the parameter adjustment apparatus may acquire an adjustment parameter for module 4 605 from the parameter adjustment model 607 and update a current parameter of module 4 605 using the acquired adjustment parameter for the module 4 605.

In operation 660, the parameter adjustment apparatus may determine current state information of module N 606 based on the output image 608 of module N−1 and a hot encoding parameter of module N 606 and may input the current state information of module N 606 to the parameter adjustment model 607.

In operation 670, the parameter adjustment apparatus may acquire an adjustment parameter for module N 606 from the parameter adjustment model 607 and update a current parameter of module N 606 using the acquired adjustment parameter for module N 606.

In this way, the parameter adjustment apparatus may acquire the output image 608 (e.g., a red, green, and blue (RGB) image) corresponding to the input image 601, which has been produced using the adjusted parameters.

In operation 680, the parameter adjustment apparatus may provide the acquired output image 608 to the state-action evaluation model 609.

In operation 690, the parameter adjustment apparatus may acquire an image quality score by evaluating the output image 608 using the state-action evaluation model 609 and may update a parameter generation method (or a parameter generation strategy) of the parameter adjustment model 607 based on the acquired image quality score.

FIG. 7 illustrates an example of a module of a parameter adjustment apparatus, according to one or more embodiments.

Referring to FIG. 7, a parameter adjustment apparatus 700 may include a state information acquisition module 710, a parameter determination module 720, and a parameter adjustment module 730.

The state information acquisition module 710 may acquire current state information indicating state information of a current image processing stage that is a target of adjustment among the image processing stages performed by an image processing system.

The state information acquisition module 710 may generate the current state information using a hot encoding parameter indicating the current image processing stage among the image processing stages and an output image of a previous stage, which is acquired by performing a previous image processing stage.

The parameter determination module 720 may determine an adjustment parameter to adjust a current parameter that is used in the current image processing stage using a parameter adjustment model to which the current state information is input and a parameter generation method indicating a method of generating the parameter that is used in image processing.

The parameter determination module 720 may acquire a current state vector by extracting a feature of the current state information from the parameter adjustment model to which the current state information is input, generate a motion vector representing, in a vector format, image processing to be performed in the current image processing stage based on the acquired current state vector and the parameter generation method, and acquire the adjustment parameter by parsing the motion vector. The parameter determination module 720 may acquire the adjustment parameter by converting the motion vector into a parameter format that is used in the image processing system. The parameter determination module 720 may acquire a semantic feature vector by extracting a feature from the output image of the previous stage and acquire the current state vector by embedding the acquired semantic feature vector and the hot encoding parameter indicating the current image processing stage. The parameter determination module 720 may acquire the motion vector by inputting the current state vector to a state-action evaluation model based on reinforcement learning, which evaluates the parameter adjustment model.

The parameter determination module 720 may acquire the semantic feature vector by extracting the feature from the output image of the previous stage and acquire the current state vector by embedding the acquired semantic feature vector and the hot encoding parameter indicating the current image processing stage. The parameter determination module 720 may acquire the motion vector by inputting the current state vector to the state-action evaluation model based on reinforcement learning, which evaluates the parameter adjustment model. The state-action evaluation model may include the parameter generation method. The parameter determination module 720 may acquire the adjustment parameter by converting the motion vector into the parameter format that is used in the image processing system.

The parameter adjustment module 730 may adjust the current parameter based on the adjustment parameter. For example, by adjusting the current parameter of the current image processing stage and then adjusting a current parameter of the next image processing stage, the parameter adjustment module 730 may sequentially adjust the current parameter of the current image processing stage and the current parameter of the next image processing stage.

The parameter adjustment apparatus 700 may further include a parameter generation method update module (not shown). The parameter generation method update module may determine a score for an evaluation item to evaluate the image processing system to which the adjustment parameter is applied. The parameter generation method update module may determine an image quality score, based on the score for the evaluation item and a weight for the evaluation item, with respect to an output image acquired from the image processing system to which the adjustment parameter is applied. The parameter generation method update module may update the parameter generation method based on the determined image quality score.

FIG. 8 illustrates an example of a configuration of a parameter adjustment apparatus, according to one or more embodiments. Referring to FIG. 8, a parameter adjustment apparatus 800 may include a memory 810 and a processor 820. The parameter adjustment apparatus 800 may correspond to the parameter adjustment apparatus 700 of FIG. 7.

The memory 810 may store instructions or code executable by the processor 820. The instructions executable by the processor 820, when executed by the processor 820, may cause the processor 820 to perform a parameter adjustment method. The memory 810 may be integrated with the processor 820. For example, random-access memory (RAM) or flash memory may be integrated with the processor 820 such as an integrated circuit microprocessor. The memory 810 may include a separate device, such as a storage device that may be used by an external disk drive, a storage array, or a database system. The memory 810 and the processor 820 may be operatively coupled or may communicate with each other via an input output (I/O) port, a network connection, or the like, such that the processor 820 may read a file stored in the memory 810. The memory 810 may be a non-transitory computer-readable storage medium that stores instructions. The instructions stored in the memory 810, when executed by the processor 820, may cause at least one processor 820 to cause the parameter adjustment apparatus 800 to perform the parameter adjustment method.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and/or other devices.

The processor 820 may execute instructions/code stored in the memory 810. The processor 820 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an ASIC, a field programmable gate array (FPGA), or any combination thereof. When the instructions are executed by the processor 820, the processor 820 may control the parameter adjustment apparatus 800 to perform the operations of the parameter adjustment method described in the present disclosure.

The parameter adjustment apparatus 800 may acquire current state information indicating state information of a current image processing stage that is a target of adjustment among the image processing stages performed by an image processing system, determine an adjustment parameter to adjust a current parameter that is used in the current image processing stage using a parameter adjustment model to which the current state information is input and a parameter generation method indicating a method of generating the parameter that is used in image processing, and adjust the current parameter based on the adjustment parameter.

By adjusting the current parameter of the current image processing stage and then adjusting a current parameter of the next image processing stage, the parameter adjustment apparatus 800 may sequentially adjust the current parameter of the current image processing stage and the current parameter of the next image processing stage.

The parameter adjustment apparatus 800 may generate the current state information using a hot encoding parameter indicating the current image processing stage among the image processing stages and an output image of a previous stage, which is acquired by performing a previous image processing stage.

The parameter adjustment apparatus 800 may acquire a current state vector by extracting a feature of the current state information from the parameter adjustment model to which the current state information is input, generate a motion vector representing, in a vector format, image processing to be performed in the current image processing stage based on the acquired current state vector and the parameter generation method, and acquire the adjustment parameter by parsing the motion vector.

The parameter adjustment apparatus 800 may acquire a semantic feature vector by extracting a feature from the output image of the previous stage and acquire the current state vector by embedding the acquired semantic feature vector and the hot encoding parameter indicating the current image processing stage.

The parameter adjustment apparatus 800 may acquire the motion vector by inputting the current state vector to a state-action evaluation model based on reinforcement learning, which evaluates the parameter adjustment model.

The parameter adjustment apparatus 800 may acquire the adjustment parameter by converting the motion vector into a parameter format that is used in the image processing system.

The parameter adjustment apparatus 800 may determine a score for an evaluation item to evaluate the image processing system to which the adjustment parameter is applied, determine an image quality score, based on the score for the evaluation item and a weight for the evaluation item, with respect to an output image acquired from the image processing system to which the adjustment parameter is applied, and update the parameter generation method based on the determined image quality score.

The parameter adjustment apparatus 800 of the example of the present disclosure may include, but is not limited thereto, devices such as a mobile phone, a laptop computer, a personal digital assistant (PDA), a pad, a desktop computer, and the like. The parameter adjustment apparatus 800 of FIG. 8 is only an example and is not intended to suggest any limitation as to the scope of use or functionality of examples of the disclosure.

According to the present disclosure, a non-transitory computer-readable storage medium (not shown) may be provided, and the non-transitory computer-readable storage medium may store one or more executable program instructions or code. The one or more executable program instructions, when executed by a computing system, may cause the computing system to perform acquiring current state information indicating state information of a current image processing stage that is a target of adjustment among the image processing stages performed by an image processing system, in which the current state information may include a hot encoding parameter indicating the current image processing stage among the image processing stages and an output image of a previous stage, which is acquired by performing a previous image processing stage, determining an adjustment parameter to adjust a current parameter that is used in the current image processing stage using a parameter adjustment model to which the current state information is input and a parameter generation method indicating a method of generating a parameter that is used in image processing, and adjusting the current parameter based on the adjustment parameter. The flexibility and efficiency of parameter adjustment may be improved by the operations of a parameter adjustment method performed by the one or more executable program instructions. A computer program included in the non-transitory computer-readable storage medium may be transmitted using any suitable medium, including but not limited to a wire, an optical cable, a radio frequency (RF), or the like, or any suitable combination thereof. The non-transitory computer-readable storage medium may be included in an arbitrary device and may exist independently without being assembled into the device.

In addition, according to examples of the present disclosure, a computer program product may be further included. Instructions of the computer program product may be executed by a processor of a computer device to perform the parameter adjustment method of the present disclosure.

The computing apparatuses, the electronic devices, the processors, the memories, the displays, the information output system and hardware, the storage devices, and other apparatuses, devices, units, modules, and components described herein, including descriptions with respect to respect to FIGS. 1-8 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus for adjusting a parameter of an image processing system comprising an image processing pipeline comprised of image processing stages, the apparatus comprising:
one or more processors; and
a memory storing instructions configured to, when executed by the one or more processors, cause the apparatus to:
acquire current state information indicating which of the image processing stages is a current image processing stage that is a target of adjustment among the image processing stages;
determine an adjustment parameter using a parameter adjustment model to which the current state information is input and using a parameter generation method that generates the adjustment parameter;
adjust a current parameter in the current image processing stage based on the adjustment parameter; and
perform the current image processing stage with the adjusted parameter therein.

2. The apparatus of claim 1, wherein the instructions, when executed by the one or more processors, cause the apparatus to, by adjusting the current parameter of the current image processing stage and by adjusting a parameter of a next image processing stage after the current image processing stage, sequentially adjust the current parameter of the current image processing stage and the parameter of the next image processing stage.

3. The apparatus of claim 1, wherein the instructions, when executed by the one or more processors, cause the apparatus to generate the current state information using a hot encoding parameter indicating the current image processing stage among the image processing stages and an output image of a previous image processing stage that is previous to the current image processing stage, which is acquired by performing the previous image processing stage.

4. The apparatus of claim 3, wherein the instructions, when executed by the one or more processors, cause the apparatus to:
acquire a current state vector by extracting, by the parameter adjustment model, a feature of the current state information;
generate a motion vector representing, in a vector format, image processing to be performed in the current image processing stage based on the acquired current state vector and based on the parameter generation method; and
acquire the adjustment parameter by parsing the motion vector.

5. The apparatus of claim 4, wherein the instructions, when executed by the one or more processors, cause the apparatus to:
acquire a semantic feature vector by extracting a feature from the output image of the previous stage; and
acquire the current state vector by embedding the acquired semantic feature vector and the hot encoding parameter indicating the current image processing stage.

6. The apparatus of claim 4, wherein the instructions, when executed by the one or more processors, cause the apparatus to acquire the motion vector by inputting the current state vector to a state-action evaluation model based on reinforcement learning, which is configured to evaluate the parameter adjustment model.

7. The apparatus of claim 6, wherein the state-action evaluation model comprises a decision-making model configured to perform the parameter generation method and a Q network configured to evaluate the current state vector.

8. The apparatus of claim 4, wherein the instructions, when executed by the one or more processors, cause the apparatus to acquire the adjustment parameter by converting the motion vector into a parameter format that is used in the image processing system.

9. The apparatus of claim 3, wherein the instructions, when executed by the one or more processors, cause the apparatus to:
determine a score for an evaluation item to evaluate the image processing system to which the adjustment parameter is applied;
determine an image quality score, based on the score for the evaluation item and a weight for the evaluation item, with respect to an output image that is acquired from the image processing system to which the adjustment parameter is applied; and
update the parameter generation method based on the determined image quality score.

10. The apparatus of claim 9, wherein the evaluation item comprises an accuracy of detailed information of the output image, a color of the output image, a contrast ratio of the output image, or a brightness of the output image.

11. A method of adjusting a parameter of an image processing system comprising an image processing pipeline comprised of image processing stages, the method comprising:
acquiring current state information indicating which of the image processing stages is a current image processing stage that is a target of adjustment among the image processing stages;
determining an adjustment parameter using a parameter adjustment model to which the current state information is input and using a parameter generation method that generates the adjustment parameter;
adjusting a current parameter in the current image processing stage based on the adjustment parameter; and
performing the current image processing stage with the adjusted parameter therein.

12. The method of claim 11, wherein the adjusting of the current parameter comprises, by adjusting the current parameter of the current image processing stage and by adjusting a parameter of a next image processing stage, sequentially adjusting the current parameter of the current image processing stage and the parameter of the next image processing stage.

13. The method of claim 11, wherein the acquiring of the current state information comprises generating the current state information using a hot encoding parameter indicating the current image processing stage among the image processing stages and using an output image of a previous image processing stage that is previous to the current image processing stage, which is acquired by performing the previous image processing stage.

14. The method of claim 13, wherein the determining of the adjustment parameter comprises:
acquiring a current state vector by extracting, by the parameter adjustment model, a feature of the current state information;
generating a motion vector representing, in a vector format, image processing to be performed in the current image processing stage based on the acquired current state vector and based on the parameter generation method; and
acquiring the adjustment parameter by parsing the motion vector.

15. The method of claim 14, wherein the acquiring of the current state vector comprises:
acquiring a semantic feature vector by extracting a feature from the output image of the previous stage; and
acquiring the current state vector by embedding the acquired semantic feature vector and the hot encoding parameter indicating the current image processing stage.

16. The method of claim 14, wherein the generating of the motion vector comprises acquiring the motion vector by inputting the current state vector to a state-action evaluation model based on reinforcement learning, which is configured to evaluate the parameter adjustment model.

17. The method of claim 16, wherein the state-action evaluation model comprises a decision-making model configured to perform the parameter generation method and a Q network configured to evaluate the current state vector.

18. The method of claim 14, wherein the acquiring of the adjustment parameter comprises acquiring the adjustment parameter by converting the motion vector into a parameter format that is used in the image processing system.

19. The method of claim 13, further comprising:
determining a score for an evaluation item to evaluate the image processing system to which the adjustment parameter is applied;
determining an image quality score, based on the score for the evaluation item and a weight for the evaluation item, with respect to an output image that is acquired from the image processing system to which the adjustment parameter is applied; and
updating the parameter generation method based on the determined image quality score.

20. A non-transitory computer-readable storage medium storing executable program instructions,
wherein the executable program instructions, when executed by a computing system, cause the computing system to perform, for an image processing pipeline comprised of image processing stages:
acquiring current state information indicating which of the image processing stages is a current image processing stage that is a target of adjustment among the image processing stages, wherein the current state information comprises a hot encoding parameter indicating the current image processing stage among the image processing stages and an output image of an image processing stage that is previous to the current image processing stage, wherein the output image is acquired by performing the previous image processing stage;
determining an adjustment parameter using a parameter adjustment model to which the current state information is input and using a parameter generation method that generates the adjustment parameter;
adjusting a current parameter in the current image processing stage based on the adjustment parameter; and
performing the current image processing stage with the adjusted parameter therein.
